(19) United States
(12) Patent Application Publication
(10) Pub. No.: US 2020/0143369 A1
(43) Pub. Date: May 7, 2020

(54) DEVICE FOR CONTRACTING SMART CONTRACT AND METHOD THEREOF

(71) Applicant: Institute For Information Industry, Taipei (TW)

(72) Inventors: Chih-Hsiang HU, Kaohsiung City (TW); Chen-Kuan TSAI, Tainan City (TW); Cheng-Yao HO, Taichung City (TW); Chi WULEE, New Taipei City (TW)

(21) Appl. No.: 16/209,915

(22) Filed: Dec. 4, 2018

(30) Foreign Application Priority Data
Nov. 1, 2018 (TW) 107138824

(51) Int. Cl. G06Q 20/38; H04L 9/06; G06F 16/182; G06Q 20/40

(52) U.S. Cl. CPC G06Q 20/3827; H04L 9/0637; H04L 2209/38; G06Q 20/401; G06F 16/1824

(57) ABSTRACT

A device for contracting smart contracts receives and stores event information provided by an organizer of an event and candidate information provided by a co-organizer candidate. The device for contracting smart contracts deploys a smart contract of the event in a block chain based on the event information, determines to assign the co-organizer candidate as a co-organizer of the event through the smart contract based on the candidate information, and records the candidate information into the smart contract to make the organizer contract with the co-organizer candidate.

### PRIORITY

This application claims priority to TW Patent Application No. 107138824 filed on Nov. 1, 2018, which is hereby incorporated by reference in its entirety.

### FIELD

Embodiments of the present invention relate to a device for contracting smart contracts. More particularly, the embodiments of the present invention relate to a device for contracting smart contracts and method for providing a contract between an organizer of an event and a co-organizer candidate.

### BACKGROUND

During preparation of an event by an organizer of the event, there is a need to recruit a plurality of co-organizers to perform the event together with the organizer or provide sponsorship required by the event. However, in the prior art, the organizer of the event can only find the co-organizers that are willing to perform the event together with the organizer or willing to provide sponsorship in the preparation stage before the event is performed so as to contract with the co-organizers according to details of the co-organizing event to establish the co-organizing relationship of the event. That is, after the organizer starts to perform the event, the organizer of the event cannot find new co-organizers, and businesses or other units that are willing to co-organize the event cannot contract with the organizer at any time to co-organize the event.

Accordingly, an urgent need exists in the art to provide a solution which enables the organizer of the event to contract with the co-organizer to co-organize the event at any time before the start of the event and during the event.

### SUMMARY

Provided is a device for contracting smart contracts. The device for contracting smart contracts may comprise an input interface, a storage and a processor connected to the storage and the input interface. The input interface may be configured to receive event information provided by an organizer of an event, and candidate information provided by a co-organizer candidate. The storage may be configured to store the event information and the candidate information. The processor may be configured to: deploy a smart contract of the event in a block chain based on the event information; determine whether to assign the co-organizer candidate as a co-organizer of the event through the smart contract based on the candidate information; and record the candidate information into the smart contract to make the organizer contract with the co-organizer candidate when determining to assign the co-organizer candidate as a co-organizer of the event.

Also provided is a method for contracting smart contracts. The method may comprise the following steps:

receiving, by a device for contracting smart contracts, event information provided by an organizer of an event, and candidate information provided by a co-organizer candidate;

storing, by the device for contracting smart contracts, the event information and the candidate information;

deploying, by the device for contracting smart contracts, a smart contract of the event in a block chain based on the event information;

determining, by the device for contracting smart contracts, whether to assign the co-organizer candidate as a co-organizer of the event through the smart contract based on the candidate information; and

recording, by the device for contracting smart contracts, when determining to assign the co-organizer candidate as a co-organizer of the event, the candidate information into the smart contract to make the organizer contract with the co-organizer candidate.

The device for contracting smart contracts pre-deploys a smart contract of the event based on the event information, and then automatically determines whether the co-organizer candidate meets the qualification of co-organizing the event at any time (e.g., before or after the start of the event) through the smart contract, thereby assigning the co-organizer candidate which meets the qualification as being the co-organizer to automatically contracts with the co-organizer. Therefore, the device for contracting smart contracts and the method for contracting smart contracts provided by the present invention indeed achieve the objective of enabling the organizer of the event to contract with the co-organizer for co-organizing the event at any time before the start of the event and during the event.

What described above is not intended to limit the present invention, but only generally describes the technical problem that can be solved by the present invention, the technical means that can be adopted and the technical effect that can be achieved so that those of ordinary skill in the art can preliminarily understand the present invention. Details of the embodiments of the present invention can be further understood by those of ordinary skill in the art according to attached drawings and contents recorded in the following embodiments.

### BRIEF DESCRIPTION OF THE DRAWINGS

FIG. 1 illustrates a schematic view of a device for contracting smart contracts according to some embodiments.

FIG. 2 illustrates a schematic flowchart diagram of the operation of the device for contracting smart contracts of FIG. 1 according to some embodiments.

FIG. 3 illustrates a schematic flowchart diagram of the operation of the device for contracting smart contracts of FIG. 1 according to some embodiments.

FIG. 4 illustrates a schematic flowchart diagram of the operation of the device for contracting smart contracts of FIG. 1 according to some embodiments.

FIG. 5 illustrates a schematic view of a method for contracting smart contracts according to some embodiments.

### DETAILED DESCRIPTION

The present invention will be described hereinafter with reference to certain example embodiments thereof. However, these example embodiments are not intended to limit the present invention to any specific examples, embodiments, operations, environment, applications, structures, processes or steps described in these example embodiments.

In the attached drawings, elements unrelated to the present invention are omitted from depiction but may be implied in the attached drawings; and dimensions of elements and proportional relationships among individual elements in the attached drawings are only exemplary examples but not intended to limit the present invention. Unless stated particularly, same (or similar) element symbols may correspond to same (or similar) elements in the following description. Unless stated particularly, the number of each element described below may be one or plural while it can be implemented.

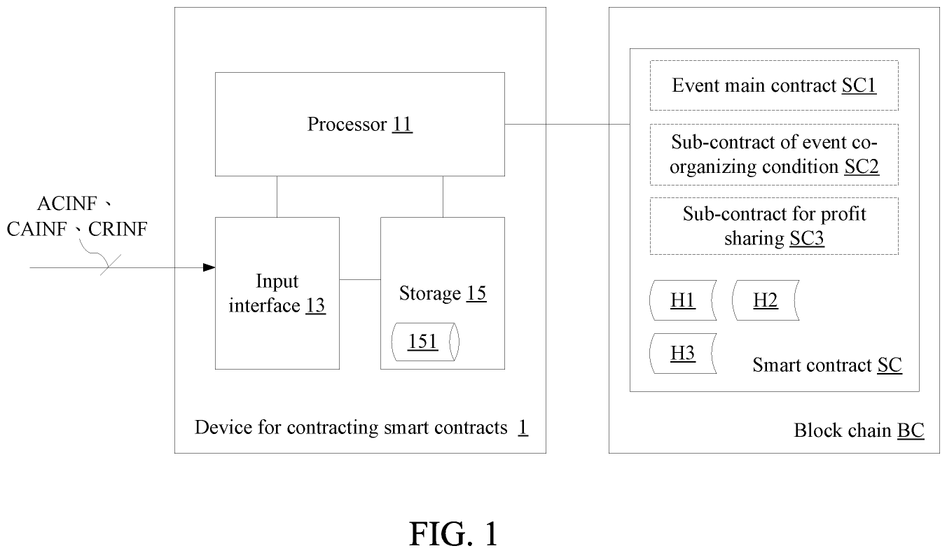

FIG. 1 illustrates a schematic view of a device for contracting smart contracts according to some embodiments. The content shown in FIG. 1 is only for illustrating the embodiments of the present invention rather than for limiting the present invention. Referring to FIG. 1, the device 1 for contracting smart contracts may basically comprise a processor 11, an input interface 13 and a storage 15, wherein the processor 11, the input interface 13 and the storage 15 may be connected with each other.

The processor 11 may be any of various microprocessors or microcontrollers capable of signal processing. The microprocessor or the microcontroller is a kind of programmable specific integrated circuit that is capable of operating, storing, outputting/inputting or the like. Moreover, the microprocessor or the microcontroller can receive and process various coded instructions, thereby performing various logical operations and arithmetical operations and outputting corresponding operation results. The processor 11 may perform various operations on various information or data so as to deploy a smart contract SC in a block chain BC. As shown in FIG. 1, the smart contract SC may comprise an event main contract SC1, an sub-contract SC2 of event co-organizing condition and an sub-contract SC3 for profit sharing or the like therein, and the smart contract SC may also record an event hash value H1, a co-organizing hash value H2 and an event record hash value H3 therein. Relevant implementation details of deploying the smart contract SC in the block chain BC by the processor 11 will be detailed hereinafter.

The input interface 13 may comprise various input/output elements comprised in general computing devices/computers for receiving data from the outside or outputting data to the outside. The input interface 13 may comprise for example (but not limited to) a mouse, a trackball, a touch panel, a keyboard, a scanner, a microphone, a user interface, a screen, a touch screen, a projector or the like. In some embodiments, the input interface 13 may comprise a human-machine interface (e.g., a graphic user interface) for facilitating the interaction of the user and the computing apparatus 11. The input interface 13 may be configured to receive various information (e.g., event information ACINF, candidate information CAINF, information CRINF of co-organizing records or the like).

The storage 15 may comprise various storage units comprised in general computing devices/computers. The storage 15 may comprise a primary memory (which is also called a main memory or internal memory) which is usually called a memory for short, and the memory at this level directly communicates with the central processor. The central processor may read instruction sets stored in the memory, and execute these instruction sets if needed. The storage 15 may further comprise a secondary memory (which is also called an external memory or auxiliary memory), and the secondary memory does not directly communicate with the central processor, but connects to the central processor via an output/input channel of the memory and uses a data buffer to transmit the data to the primary memory. The data of the secondary memory does not disappear (i.e., is non-volatile) without power supply. The secondary memory may for example be one of various types of hard disks, optical disks or the like. The storage 15 may also comprise a third-level storage device, i.e., a storage device that can be inserted into or pulled out from a computer directly, e.g., a mobile disk. The storage 15 may be configured to store template information 151 of the smart contract and various information received via the input interface 13.

The connection relationship mentioned herein may be direct connection (i.e., connection not via other elements with specific functions) or indirect connection (i.e., connection via other elements with specific functions) depending on different requirements.

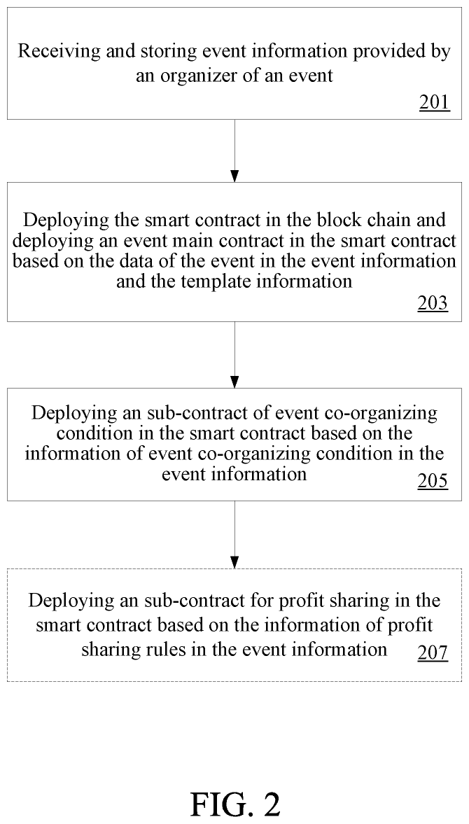

FIG. 2 illustrates a schematic flowchart diagram of deploying the smart contract SC by the device 1 for contracting smart contracts of FIG. 1 according to some embodiments. The content shown in FIG. 2 is only for illustrating the embodiments of the present invention rather than for limiting the present invention. Referring to FIG. 1 and FIG. 2, the device 1 for contracting smart contracts may receive and store event information ACINF provided by an organizer of an event (shown as action 201). In detail, the device 1 for contracting smart contracts may receive event information ACINF provided by an organizer of an event via the input interface 13, and store the event information ACINF into the storage 15. The event information ACINF may comprise data of the event and information of event co-organizing condition. The data of the event may comprise for example (but not limited to): an event name, an event site, an event time and an event type. The information of event co-organizing condition may comprise event co-organizing conditions that are set by the organizer in response to the event, which are for example but not limited to: the distance between the site of the co-organizer and the site of the event must be within a specific distance, e.g., 5 kilometers, and the co-organizer is a business of a particular type, e.g., a catering business or a transportation business or the like. The input interface 13 may provide various graphic interfaces for inputting the event information ACINF by the organizer or the user, and after the input interface 13 receives the event information ACINF, the processor 11 may store various data in the received event information ACINF into the storage 15 via files of a text format or other formats (which are for example but not limited to an extensible markup language (XML) format, a JavaScript Object Notation (JSON) format or the like).

Next, the processor 11 may be configured to deploy the smart contract SC in the block chain BC and deploy an event main contract SC1 in the smart contract SC based on the data of the event in the event information ACINF and the template information 151 of the smart contract that is stored in the storage 15 (shown as action 203). In detail, the processor 11 may apply the data of the event to a smart contract template in the template information 151 of the smart contract that is pre-stored so as to deploy the event main contract SC1 in the smart contract SC. That is to say, the event main contract SC1 at least records the profile data of the event or the like. The processor 11 may interpret the event information ACINF into the smart contract SC via a contract oriented language (which is for example but not limited to: Solidity) or via other types of program languages (which are for example but not limited to: C++, Python, JavaScript), and then deploy the smart contract SC onto the block chain BC. The technology of deploying the smart contract SC on the block chain BC by the processor 11 is known by those of ordinary skill in the art, and thus will not be further described herein. In some embodiments, the address of the event main contract SC1 in the block chain BC may be recorded in the smart contract SC. In some embodiments, the processor 11 may not need to deploy the event main contract SC1 for recording the data of the event, and instead, the processor 11 may directly record the data of the event in the smart contract SC. That is, in the case where the aforesaid event main contract SC1 is not deployed, the smart contract SC may comprise all the functions of the event main contract SC1.

During the process of deploying the smart contract SC, the processor 11 may also deploy an sub-contract SC2 of event co-organizing condition in the smart contract SC based on the information of event co-organizing condition in the event information ACINF (shown as action 205). In detail, the processor 11 may interpret the event co-organizing condition stored in the storage 15 into the sub-contract SC2 of event co-organizing condition in the smart contract SC via a contract type language or via other types of program languages, and then deploy the sub-contract SC2 of event co-organizing condition onto the block chain BC. That is, the sub-contract SC2 of event co-organizing condition records the aforesaid event co-organizing condition. In some embodiments, the processor 11 may record the address of the sub-contract SC2 of event co-organizing condition in the block chain BC into the smart contract SC or the event main contract SC1 to deploy the correlation between the sub-contract SC2 of event co-organizing condition and the smart contract SC or the event main contract SC1. In some embodiments, the processor 11 may not need to deploy the sub-contract SC2 of event co-organizing condition for recording the aforesaid event co-organizing conditions, and instead, the processor 11 may directly record the event co-organizing conditions in the smart contract SC. That is, in the case where the aforesaid sub-contract SC2 of event co-organizing condition is not deployed, the smart contract SC may comprise all the functions of the sub-contract SC2 of event co-organizing condition.

In some embodiments, the event information ACINF may further comprise information of profit sharing rules provided by the organizer of the event, and the information of profit sharing rules may comprise rules of performing profit sharing between the organizer of the event and the co-organizer during the event or after the event is ended, which are for example but not limited to: sharing rules of bonus (which are for example but not limited to: averagely sharing all the bonus between all the co-organizers of the event, sharing the bonus based on the proportions of sponsorships provided by all the co-organizers, or sharing the bonus based on the proportions of the data of trading records in the information of co-organizing records of all the co-organizers), calculating rules of the bonus (which are for example but not limited to: allocating a same bonus to a certain co-organizer at each time, or determining the corresponding bonus of each time based on each data of trading records of a certain co-organizer) and calculating periods of the profit sharing (which are for example but not limited to: calculating the shared bonus each time a piece of data of trading records is received, calculating the shared bonus every day, or calculating the total shared bonus after the event is ended). The information of profit sharing rules may be stored in the storage 15.

Optionally, during the process of deploying the smart contract SC, the processor 11 may also deploy an sub-contract SC3 for profit sharing in the smart contract SC based on the information of profit sharing rules in the event information ACINF (shown as action 207). In detail, the processor 11 may interpret the event profit sharing rule stored in the storage 15 into the sub-contract SC3 for profit sharing in the smart contract SC via a contract type language or via other types of program languages, and then deploy the sub-contract SC3 for profit sharing onto the block chain BC. That is, the sub-contract SC3 for profit sharing records the aforesaid event profit sharing rule. In some embodiments, the processor 11 may record the address of the sub-contract SC3 for profit sharing in the block chain BC into the smart contract SC or the event main contract SC1 to establish the correlation between the sub-contract SC3 for profit sharing and the smart contract SC or the event main contract SC1. In some embodiments, the processor 11 may not need to deploy the sub-contract SC3 for profit sharing for recording the aforesaid event profit sharing rule, and instead, the processor 11 may directly record the event profit sharing rule in the smart contract SC. That is, in the case where the aforesaid sub-contract SC3 for profit sharing is not deployed, the smart contract SC may comprise all the functions of the sub-contract SC3 for profit sharing.

The order of the actions 201 to 207 as shown in FIG. 2 is not limited. The order of the actions 201 to 207 as shown in FIG. 2 may be adjusted while it can still be implemented.

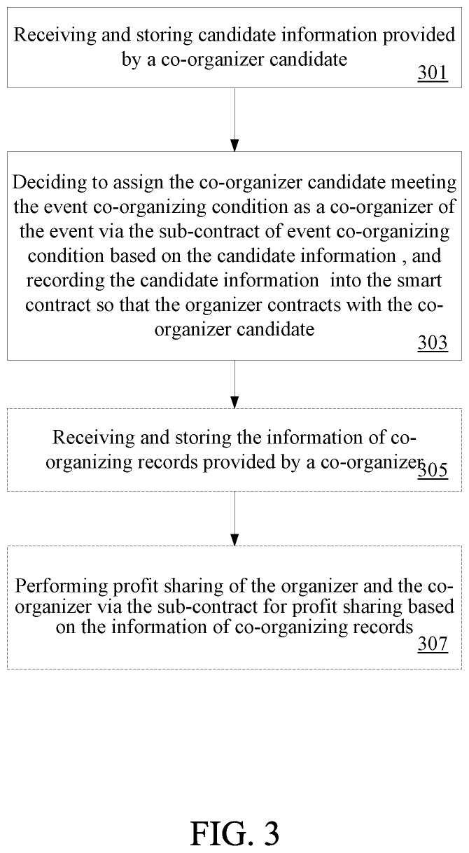

FIG. 3 illustrates a schematic flowchart diagram of executing the smart contract SC by the device 1 for contracting smart contracts of FIG. 1 according to some embodiments. The content shown in FIG. 3 is only for illustrating the embodiments of the present invention rather than for limiting the present invention. Referring to FIG. 1 and FIG. 3, the device 1 for contracting smart contracts may receive and store candidate information CAINF provided by a co-organizer candidate (shown as action 301). In detail, the device 1 for contracting smart contracts may receive the candidate information CAINF provided by a co-organizer candidate via the input interface 13, and store the candidate information CAINF into the storage 15. The candidate information CAINF may comprise profile data of the co-organizer candidate which are for example (but not limited to): a site of the co-organizer candidate, and a business type of the co-organizer candidate (e.g., whether the co-organizer candidate is a catering business or transportation business) or the like.

Next, the processor 11 may decide to assign the co-organizer candidate meeting the event co-organizing condition as a co-organizer of the event via the sub-contract SC2 of event co-organizing condition based on the candidate information CAINF, and record the candidate information CAINF into the smart contract SC so that the organizer contracts with the co-organizer candidate (shown as action 303). In detail, the processor 11 may determine whether the candidate meets the event co-organizing condition of the event by comparing the candidate information CAINF (e.g., the profile data of the candidate) with the event co-organizing condition recorded in the sub-contract SC2 of event co-organizing condition via the sub-contract SC2 of event co-organizing condition. If the candidate information CAINF meets the event co-organizing condition of the event, the candidate is assigned as a co-organizer of the event, and the candidate information CAINF is recorded into the event main contract SC1 in the smart contract SC so that the organizer contracts with the co-organizer candidate. For example, the event co-organizing condition recorded in the sub-contract SC2 of event co-organizing condition may be that: the distance between the site of the co-organizer and the site of the event must be within 5 kilometers, and the co-organizer must be a catering business. The distance between the site of the candidate and the site of the event is 3 kilometers, and the candidate is a catering business, so the processor 11 determines that the candidate meets the event co-organizing condition via the sub-contract SC2 of event co-organizing condition, assigns the candidate as a co-organizer of the event, and records the candidate information CAINF of the co-organizing candidate into the event main contract SC1 in the smart contract SC so that the organizer contracts with the co-organizer candidate.

In some embodiments, the device 1 for contracting smart contracts may receive the candidate information provided by a co-organizer candidate, and search for a plurality of events matching with the candidate information, and then recommend the plurality of events to the co-organizer candidate so that the co-organizer candidate can make a decision whether to co-organize the event. In some other embodiments, the device 1 for contracting smart contracts may receive the candidate information provided by a co-organizer candidate and event type information regarding events that the candidate intends to co-organize, and search for a plurality of events matching with the candidate information and the event type information, and then recommend the plurality of events to the co-organizer candidate so that the co-organizer candidate can make a decision whether to co-organize the event.

In some embodiments, optionally, the device 1 for contracting smart contracts may further receive and store the information CRINF of co-organizing records provided by a co-organizer (shown as action 305). In detail, in the case where the co-organizer has contracted with the organizer, the device 1 for contracting smart contracts may receive the information CRINF of co-organizing records provided by the co-organizer via the input interface 13, and the information CRINF of co-organizing records may comprise data to be verified and data of trading records. The data to be verified may comprise a serial number or identification code of an event ticket or voucher, and the data of trading records may comprise relevant trading record of an trading event performed by a participator (or a consumer) of the event when participating in the event via an event ticket or voucher at the co-organizer.

In some embodiments, after the receiving interface 13 receives the information CRINF of co-organizing records, the processor 11 may perform verification on the data to be verified to determine whether the data to be verified is correct. For example, when the participator (or the consumer) performs the trading event with the co-organizer when participating in the event, the co-organizer may transmit the information of co-organizing records to the device 1 for contracting smart contracts via various mobile devices or via a network. In the case where the data to be verified is a serial number of an event ticket, the processor 11 may compare the serial number of the ticket with a pre-stored correct serial number whitelist. If the serial number of the ticket conforms to one of the serial numbers of the correct serial number whitelist, then it is determined that the ticket serial number is correct.

In some other embodiments, before the receiving interface 13 receives the information CRINF of co-organizing records, the data to be verified in the information CRINF of co-organizing records has been verified as the correct data to be verified by an external electronic device or system (not shown), and then the receiving interface 13 receives the information CRINF of co-organizing records. For example, when the participator (or the consumer) has a piece of trading with the co-organizer when participating in the event, the co-organizer may first verify the data to be verified of the information CRINF of co-organizing records via an external electronic device or system (e.g., one of various ticketing systems or devices, or one of various ticket verifying systems or devices), and only after the data to be verified is verified as correct, the information CRINF of co-organizing records is transmitted to the device 1 for contracting smart contracts via various mobile devices or via the network.

In some embodiments, optionally, in the case where the device 1 for contracting smart contracts further receives and stores the information CRINF of co-organizing records provided by the co-organizer, the processor 11 may perform profit sharing of the organizer and the co-organizer via the sub-contract SC3 for profit sharing based on the information CRINF of co-organizing records (shown as action 307). In detail, the processor 11 may record the data of trading records in the information CRINF of co-organizing records into the event main contract SC1 of the smart contract SC, and then perform the profit sharing of the organizer and the co-organizer via the sub-contract SC3 for profit sharing in the smart contract SC based on the event information and the data of trading records.

In some embodiments, only after the data to be verified corresponding to the data of trading records is verified to be correct, the processor 11 records the data of trading records to the smart contract SC. In some embodiments, the processor 11 may first perform a hash operation on the data of trading records and then record the result of the operation into the event main contract SC1 when the recording the data of trading is recorded by the smart contract SC. In some embodiments, recording the data of trading records by the smart contract SC through the processor 11 is to record the number of times of trading performed by the consumer to the co-organizer. For example, when the processor 11 records the data of trading records into the smart contract SC, the value of a parameter for recording the number of times of trading in the event main contract SC1 of the smart contract SC is increased by one. During the process of performing a profit sharing of the organizer and the co-organizer via the sub-contract SC3 for profit sharing in the smart contract SC based on the event information and the data of trading records, the processor 11 may perform the profit sharing via the event profit sharing rule recorded in the sub-contract SC3 for profit sharing and the number of times of trading recorded in the event main contract SC1.

The order of the actions 301 to 307 as shown in FIG. 3 is not limited. The order of the actions 301 to 307 as shown in FIG. 3 may be adjusted while it can still be implemented.

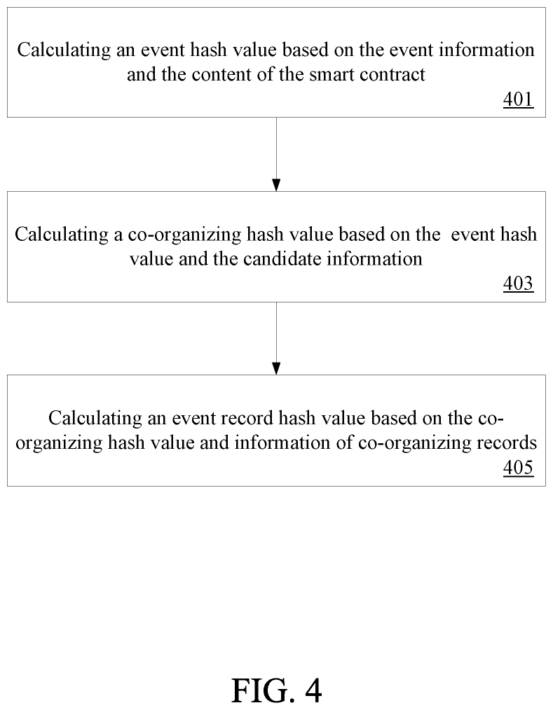

FIG. 4 illustrates a schematic view of recording an event record hash value by the device 1 for contracting smart contracts of FIG. 1 according to some embodiments. The content shown in FIG. 4 is only for illustrating the embodiments of the present invention rather than for limiting the present invention. Referring to FIG. 4, the processor 11 may calculate an event hash value H1 based on the event information ACINF and the content of the smart contract SC (shown as action 401). In detail, the processor 11 may merge the data of the event, the event co-organizing condition, the event profit sharing rule or the like in the event information ACINF with the content of the smart contract SC (which includes for example but not limited to an address of the event main contract SC1, an address of the sub-contract SC2 of event co-organizing condition, an address of the sub-contract SC3 for profit sharing, a time stamp where the event main contract SC1 is deployed, a time stamp where the sub-contract SC2 of event co-organizing condition is deployed, a time stamp where the sub-contract SC3 for profit sharing is deployed and an event public key of the organizer or the like) and convert them into one event hash value H1, and record the event hash value H1 into the smart contract SC.

In some embodiments, after the action 401 is executed, the processor 11 may further calculate a co-organizing hash value H2 based on the event hash value H1 and the candidate information CAINF (shown as action 403). In detail, the processor 11 may merge the event hash value H1, the candidate profile data in the candidate information CAINF and a co-organizer public key or the like and convert them into one co-organizing hash value H2, and record the co-organizing hash value H2 into the smart contract SC.

In some embodiments, after the actions 401 and 403 are executed, the processor 11 may further calculate an event record hash value H3 based on the co-organizing hash value H2 and the information CRINF of co-organizing records (shown as action 405). In detail, the processor 11 may merge the event record hash value H3, the data to be verified and the data of trading records in the information CRINF of co-organizing records, and a co-organizer public key or the like and convert them into an event record hash value H3, and record the event record hash value H3 into the smart contract SC. In some embodiments, the processor 11 may merge the event record hash value H3 recorded in the smart contract SC with the new information CRINF of co-organizing records and perform a hush operation each time the information CRINF of co-organizing records is received (i.e., each time a piece of new trading is established), and then update and record the new information CRINF of co-organizing records into the smart contract SC.

The aforesaid operation of calculating the event hash value H1, the co-organizing hash value H2 and the event record hash value H3 via the hash operation by the processor 11 shall be known by those of ordinary skill in the art, and thus will not be further described herein.

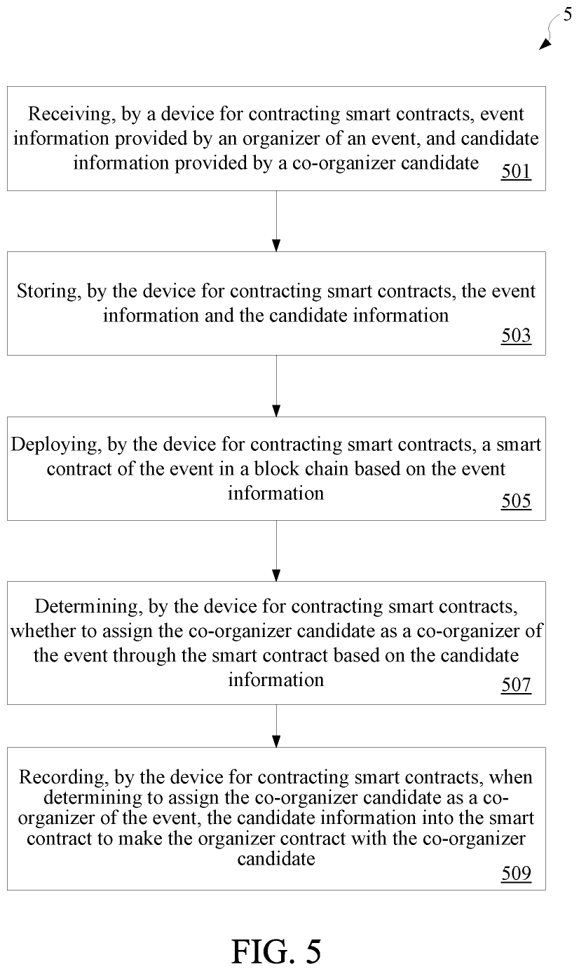

FIG. 5 illustrates a schematic view of a method for contracting smart contracts according to some embodiments. The content shown in FIG. 5 is only for illustrating the embodiments of the present invention rather than for limiting the present invention. Referring to FIG. 5, a method 5 for contracting smart contracts may comprise the following steps:

receiving, by a device for contracting smart contracts, event information provided by an organizer of an event, and candidate information provided by a co-organizer candidate (shown as step 501);

storing, by the device for contracting smart contracts, the event information and the candidate information (shown as step 503);

deploying, by the device for contracting smart contracts, a smart contract of the event in a block chain based on the event information (shown as step 505);

determining, by the device for contracting smart contracts, whether to assign the co-organizer candidate as a co-organizer of the event through the smart contract based on the candidate information (shown as step 507); and

recording, by the device for contracting smart contracts, when determining to assign the co-organizer candidate as a co-organizer of the event, the candidate information into the smart contract to make the organizer contract with the co-organizer candidate (shown as step 509).

The order of the steps 501 to 509 as shown in FIG. 5 is not limited. The order of the steps 501 to 507 as shown in FIG. 5 may be adjusted while it can still be implemented.

In some embodiments, the event information further comprises data of the event, the device for contracting smart contracts further stores template information of the smart contract, and the device for contracting smart contracts deploys the smart contract based on the data of the event and the template information of the smart contract.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records.

The event information further comprises information of profit sharing rules, the smart contract further comprises an sub-contract for profit sharing, and the device for contracting smart contracts performs a profit sharing of the organizer and the co-organizer through the sub-contract for profit sharing based on the information of profit sharing rules and the information of co-organizing records.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition, and the information of co-organizing records comprises data to be verified and a data of trading records. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records.

The device for contracting smart contracts verifies whether the data to be verified is correct, and if the data to be verified is correct, the data of trading records is recorded by the smart contract through the device for contracting smart contracts to perform a profit sharing of the organizer and the co-organizer through the smart contract based on the event information and the data of trading records.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records;

wherein the information of co-organizing records comprises data to be verified and data of trading records, the data to be verified is verified as correct by an external electronic device, and the data of trading records is recorded by the smart contract through the device for contracting smart contracts to perform a profit sharing of the organizer and the co-organizer through the smart contract based on the event information and the data of trading records.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records; and

calculating, by the device for contracting smart contracts, an event hash value based on the event information and content of the smart contract, and recording the event hash value into the smart contract.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records;

calculating, by the device for contracting smart contracts, an event hash value based on the event information and content of the smart contract, and recording the event hash value into the smart contract; and

calculating, by the device for contracting smart contracts, a co-organizing hash value based on the event hash value and the candidate information, and recording the co-organizing hash value into the smart contract.

In some embodiments, the event information further comprises information of event co-organizing condition, the smart contract further comprises an sub-contract of event co-organizing condition, and the device for contracting smart contracts determines whether to assign the co-organizer candidate as a co-organizer of the event by comparing the information of event co-organizing condition with the candidate information through the sub-contract of event co-organizing condition. Furthermore, in addition to the steps 501 to 509, the method 5 for contracting smart contracts may further comprise following steps:

receiving, by the device for contracting smart contracts, information of co-organizing records of the co-organizer; and

recording, by the device for contracting smart contracts, the information of co-organizing records into the smart contract to perform a profit sharing of the organizer and the co-organizer through the smart contract based on the event information and the information of co-organizing records;

calculating, by the device for contracting smart contracts, an event hash value based on the event information and content of the smart contract, and recording the event hash value into the smart contract;

calculating, by the device for contracting smart contracts, a co-organizing hash value based on the event hash value and the candidate information, and recording the co-organizing hash value into the smart contract; and

calculating, by the device for contracting smart contracts, an event record hash value based on the co-organizing hash value and the information of co-organizing records, and recording the event record hash value into the smart contract.

In some embodiments, all of the aforesaid steps of the method 5 for contracting smart contracts may be executed by the device 1 for contracting smart contracts. In addition to the aforesaid steps, the method 5 for contracting smart contracts may also comprise other steps corresponding to all the aforesaid embodiments of the device 1 for contracting smart contracts. These other steps shall be appreciated by those of ordinary skill in the art based on the above description of the device 1 for contracting smart contracts, and thus will not be further described herein.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A device for contracting smart contracts, comprising:
an input interface, being configured to receive event information provided by an organizer of an event, and candidate information provided by a co-organizer candidate;
a storage, being configured to store the event information and the candidate information; and
a processor, being connected to the storage and the input interface, and being configured to:
deploy a smart contract of the event in a block chain based on the event information;
determine whether to assign the co-organizer candidate as a co-organizer of the event through the smart contract based on the candidate information; and
record the candidate information into the smart contract to make the organizer contract with the co-organizer candidate when determining to assign the co-organizer candidate as a co-organizer of the event.

2. The device for contracting smart contracts of claim 1, wherein:
the event information further comprises data of the event;
the storage further stores a template information of the smart contract; and
the processor deploys the smart contract based on the data of the event and the template information of the smart contract.

3. The device for contracting smart contracts of claim 1, wherein:
the event information further comprises information of event co-organizing condition;
the smart contract further comprises an sub-contract of event co-organizing condition; and
the processor determines whether to assign the co-organizer candidate as a co-organizer of the event by comparing the information of event co-organizing condition with the candidate information through the sub-contract of event co-organizing condition.

4. The device for contracting smart contracts of claim 3, wherein:
the input interface further receives information of co-organizing records of the co-organizer; and
the processor further records the information of co-organizing records into the smart contract to perform a profit sharing of the organizer and the co-organizer through the smart contract based on the event information and the information of co-organizing records.

5. The device for contracting smart contracts of claim 4, wherein:
the event information further comprises information of profit sharing rules;
the smart contract further comprises an sub-contract for profit sharing; and
the processor performs the profit sharing of the organizer and the co-organizer through the sub-contract for profit sharing based on the information of profit sharing rules and the information of co-organizing records.

6. The device for contracting smart contracts of claim 4, wherein:
the information of co-organizing records comprises data to be verified and data of trading records; and
the processor further verifies whether the data to be verified is correct, and if the data to be verified is correct, the data of trading records is recorded by the smart contract through the processor to perform the profit sharing of the organizer and the co-organizer through the smart contract based on the event information and the data of trading records.

7. The device for contracting smart contracts of claim 4, wherein:
the information of co-organizing records comprises data to be verified and data of trading records;
the data to be verified is verified as correct by an external electronic device; and
the data of trading records is recorded by the smart contract through the processor to perform the profit sharing of the organizer and the co-organizer through the smart contract based on the event information and the data of trading records.

8. The device for contracting smart contracts of claim 4, wherein:
the processor further calculates an event hash value based on the event information and content of the smart contract, and the event hash value is recorded by the smart contract through the processor.

9. The device for contracting smart contracts of claim 8, wherein:
the processor further calculates a co-organizing hash value based on the event hash value and the candidate information, and records the co-organizing hash value into the smart contract.

10. The device for contracting smart contracts of claim 9, wherein:
the processor further calculates an event record hash value based on the co-organizing hash value and the information of co-organizing records, and records the event record hash value into the smart contract.

11. A method for contracting smart contracts, comprising:
receiving, by a device for contracting smart contracts, event information provided by an organizer of an event, and candidate information provided by a co-organizer candidate;
storing, by the device for contracting smart contracts, the event information and the candidate information;
deploying, by the device for contracting smart contracts, a smart contract of the event in a block chain based on the event information;
determining, by the device for contracting smart contracts, whether to assign the co-organizer candidate as a co-organizer of the event through the smart contract based on the candidate information; and
recording, by the device for contracting smart contracts, when determining to assign the co-organizer candidate as a co-organizer of the event, the candidate information into the smart contract to make the organizer contract with the co-organizer candidate.

12. The method for contracting smart contracts of claim 11, wherein:
the event information further comprises data of the event;
the device for contracting smart contracts further stores a template information of the smart contract; and
the device for contracting smart contracts deploys the smart contract based on the data of the event and the template information of the smart contract.

13. The method for contracting smart contracts of claim 11, wherein:
the event information further comprises information of event co-organizing condition;
the smart contract further comprises an sub-contract of event co-organizing condition; and
the device for contracting smart contracts determines whether to assign the co-organizer candidate as a co-organizer of the event by comparing the information of event co-organizing condition with the candidate information through the sub-contract of event co-organizing condition.

14. The method for contracting smart contracts of claim 13, further comprising:
receiving, by the device for contracting smart contracts, information of co-organizing records of the co-organizer; and
recording, by the device for contracting smart contracts, the information of co-organizing records into the smart contract to perform a profit sharing of the organizer and the co-organizer through the smart contract based on the event information and the information of co-organizing records.

15. The method for contracting smart contracts of claim 14, wherein:
the event information further comprises information of profit sharing rules;
the smart contract further comprises an sub-contract for profit sharing; and
the device for contracting smart contracts performs the profit sharing of the organizer and the co-organizer through the sub-contract for profit sharing based on the information of profit sharing rules and the information of co-organizing records.

16. The method for contracting smart contracts of claim 14, wherein the information of co-organizing records comprises data to be verified and data of trading records; and the method further comprises:
verifying, by the device for contracting smart contracts, whether the data to be verified is correct, and if the data to be verified is correct, recording the data of trading records into the smart contract to perform the profit sharing of the organizer and the co-organizer through the smart contract based on the event information and the data of trading records.

17. The method for contracting smart contracts of claim 14, wherein:
the information of co-organizing records comprises data to be verified and data of trading records;
the data to be verified is verified as correct by an external electronic device; and
the data of trading records is recorded by the smart contract through the device for contracting smart contracts to perform the profit sharing of the organizer and the co-organizer through the smart contract based on the event information and the data of trading records.

18. The method for contracting smart contracts of claim 14, further comprising:
calculating, by the device for contracting smart contracts, an event hash value based on the event information and content of the smart contract, and recording the event hash value into the smart contract.

19. The method for contracting smart contracts of claim 18, further comprising:
calculating, by the device for contracting smart contracts, a co-organizing hash value based on the event hash value and the candidate information, and records the co-organizing hash value into the smart contract.

20. The method for contracting smart contracts of claim 19, further comprising:
calculating, by the device for contracting smart contracts, an event record hash value based on the co-organizing hash value and the information of co-organizing records, and records the event record hash value into the smart contract.
